(19) United States
(12) Patent Application Publication
(10) Pub. No.: US 2003/0128985 A1
(43) Pub. Date: Jul. 10, 2003

(54) Modular optical network node

(76) Inventors: Jorg-Peter Elbers, Munchen (DE); Christoph Glingener, Feldkirchen-Westerham (DE); Christian Scheerer, Ottawa Ontario (CA)

Correspondence Address: BELL, BOYD & LLOYD, LLC, P. O. BOX 1135, CHICAGO, IL, 60690-1135, US

(21) Appl. No.: 10/343,271

(22) PCT Filed: Jul. 9, 2001
(86) PCT No.: PCT/DE01/02552

(30) Foreign Application Priority Data
Jul. 27, 2000 (DE) 10036700.3

(51) Int. Cl. H04L 12/28

(52) U.S. Cl. 398/83

(57) ABSTRACT

The invention relates to a modular optical network node, which divides the optical input signals into optical subbands, processed by a central element or by several central elements and which then recombines the optical subbands once again to form an optical output signal. Various functionalities, such as add-drop functionality, a drop and continue functionality, a multicast functionality, a broadcast functionality, a ring interconnect functionality, and a cross connect functionality, can be assigned to the central element or to the central elements of the modular optical network node. According to the assignment of a functionality, the modular optical network node can be used in networks having a different structure.

The invention relates to a modular optical network node which can perform an interconnection of optical signals on a subband basis and to a method for transmitting optical signals in optical network devices via said modular optical network nodes.

Optical networks use the large available bandwidth (>10 THz with monomode fibers) of optical fibers to transmit messages. For effective utilization of the available transmission capacity, the overall bandwidth is expediently subdivided further. This is usually achieved in systems having a high transmission capacity through the use of wavelength division multiplexers, that is to say by a transmission of various channels on different optical carrier wavelengths.

Information is typically transmitted on the basis of optical networks using a hierarchical network structure. The transitions between the individual hierarchical levels are achieved by means of network nodes. Network nodes are however also required to set up intermeshed network topologies of the same hierarchical level. Moreover, network nodes can be used to enable optical network elements to access particular wavelengths or wavelength ranges. Depending on how they are used, network nodes having different functionalities exist (e.g. OADMs, i.e. optical add/drop multiplexers, ring interconnects or optical cross-connects).

In previous solutions, optical network nodes are employed for the switching of information or the access to information, or a combination of both. In the case of information switching, optical multiplex trunking switches (OXC, i.e. optical cross-connects) are employed which perform switching on a wavelength basis. However, wavelength switching on the basis of individual wavelengths leads to very complex solutions for switching concepts and the construction of optical network nodes if large transmission capacities are wanted together with a large number of channels.

In the case of the desired large numbers of channels, non-blocking multiplex trunking switches require a large number of optical switches which render technical realization more difficult and also entail considerable costs. Moreover, the wavelength matrix of the channels is permanently defined by the multiplexers and demultiplexers in the optical switching nodes. An adaptation to, for example, different types of fiber or an expansion by increasing the number of channels is therefore only possible with great difficulty.

The object of the invention is therefore to disclose a flexible and low-cost realization of a modular optical network node for the transmission of information and/or access to information, in particular with high transmission capacities and large numbers of channels.

This object is achieved by a modular optical network node which can perform an interconnection of optical signals on a subband basis in accordance with claim 1. An associated method and an associated use are disclosed in independent claims. Advantageous further developments are disclosed in the subclaims.

In particular, the object is achieved by a modular optical network node which comprises at least one module for selecting subbands, and in which the module for selecting subbands has at least one preselection means for preselecting at least one optical subband, at least one subband multiplexing device and at least one subband demultiplexing device, and additionally at least one central element is provided. The preselection means serves here preferably to divide the connected available optical bandwidth of an optical signal. By means of the preselection means and the at least one subband demultiplexing device, the module for selecting subbands is able to select subbands of an available optical bandwidth and switch them via at least one central element, as well as process them further as required.

The preselection means for preselecting at least one optical subband is designed in such a way that the subband structure, or division of the available optical bandwidth into individual subbands respectively, can be defined or predetermined therewith. The preselection means can divide the optical bandwidth into subbands on the basis of a fixed predetermined setting here. It is particularly preferred if the preselection means is configurable, i.e. it is possible to modify the determinability of the subbands by the preselection means. It is very particularly preferred if the preselection means can be remotely configured. There are two particularly preferred options for this: in centrally controlled networks, remote configurability can be achieved with a network management system by means of a software solution. The preselection means can then be realized by a software solution in the network management and correspond to values in tables that are forwarded to the demultiplexing device, or to the filter arrangement located there respectively, in order to preselect the physical control variables in such a way that the available optical bandwidth is divisible into the predetermined subbands. It is very particularly preferred if the preselection means is a memory means in which the values that correspond to the respective subband divisions are stored. In other networks, e.g. mesh networks, on the other hand, remote configurability of the preselection means can be expediently achieved by an intelligence that is present in every preselection means itself. The reconfigurability of said preselection means is then achieved by means of suitable protocols.

The subband demultiplexing device is preferably a demultiplexer based on a filter arrangement. The subband demultiplexer can comprise a combination of couplers, filters and circulators. These may comprise tunable or fixed filters, such as fiber Bragg gratings, integrated optical filters, micro-optical arrangements or interference filters for example. It is particularly preferred if the subband demultiplexing device does not comprise individual optical components, but rather comprises smaller complete components or one entire complete component.

The subband multiplexing device is a coupler which reintegrates the signals of the subbands to be combined. A combination of a coupler and at least one filter is particularly preferred, and only one component, such as an integrated multiplexer, is very particularly preferred. A crosstalk suppression and a lower attenuation of the signal to be processed can be advantageously achieved with said integrated multiplexer.

The central element defines the interconnection of the subbands connected to the modular optical network node. The predetermined interconnection of the central element is preferably stored on a card group. The central elements are preferably exchangeable, i.e. it is possible to change the central elements assigned to the modules for selecting subbands, or to replace them by other central elements having a different interconnection and consequently a different functionality, depending on which interconnection the network device requires in each case. The number of modules preferably corresponds to the number of fibers connected, while the number of central elements preferably corresponds to the number of subbands. It is very particularly preferred if the number of modules corresponds to the number of fibers connected. It is likewise very particularly preferred if the number of central elements corresponds to the number of subbands. It is preferred if the interconnection of the central elements is modifiable. It is particularly preferred if the modification of the interconnection of the central elements is performed by means of reconfiguration.

This confers the advantage that the wavelength switching by the central elements can be performed not only on the basis of an individual, specific wavelength, but is determined in particular on the basis of a multiplicity of wavelengths (e.g. wavelength groups) determined by the bandwidth of the respective subband. If the central elements are cross-connects for example, then the interconnection of subbands (wavelength bands) instead of wavelengths leads to a considerable reduction in the size of the switching matrices. In the case of the future intended switching of high transmission rates with large numbers of channels, a large number of optical switches are consequently saved in comparison with a realization on the basis of individual wavelengths.

The switching of information by the modular optical network nodes is not restricted here solely on the basis of a switching of wavelengths or wavelength bands. The information transmitted by the subbands may be of any nature. Information can be transmitted in the subbands, for example by means of an optical code-division multiplexing method (in which all channels extend over the overall bandwidth) or else by means of a time-division multiplexing method (high-speed time-division multiplex signal of a large spectral width).

The modular optical network node can preferably dynamically select the optical subbands by means of the modules for selecting subbands from the available optical bandwidth of an optical signal. By virtue of the dynamic selection of the subbands, in particular by the preselection means, the bandwidth is dynamically assigned to the subbands, that is to say the preselection means can organize flexibly possible channel numbers, channel widths, channel spacings, modulation formats, etc.

As a result, the modular optical network node is able to respond more flexibly to changing traffic conditions. The dynamic bandwidth assignment may be remotely configurable, which further increases the flexibility and the field of application of the module for selecting subbands, and consequently of the modular optical network node.

Very particularly preferred is a modular optical network node in which a fixed predetermined central frequency is variable in the selection of the width of the optical subbands but, even with a defined subband width, can select subbands around different central frequencies. Particularly preferred here is the selection of different or a plurality of central frequencies with variable channel or subband widths. As a result, any subband patterns can be put together by the preselection means.

It is particularly advantageous that a modular optical network node can be used in networks having any type of structure and offers a different functionality, depending on application and capacity level, by means of the central element. It is particularly preferred if each of the central elements of the modular optical network node is a circuits with add/drop functionality; and/or a circuit with drop and continue functionality; and/or a circuit with multicast functionality; and/or a circuit with broadcast functionality; and/or a circuit with ring interconnect functionality; and/or a circuit with cross-connect functionality. As a result, different optical network devices can be realized by the modular optical network node according to the invention, depending on which functionality is assigned to the network device. Since the modular optical network node is always equipped with the same basic modules, costs can be saved and operation and maintenance can be simplified.

A central element of the modular optical network node preferably has at least one local add/drop stage. In contrast to the central element with add/drop functionality, the local add/drop stage works with even lower granularity. If the central element with add/drop functionality accesses subbands, then the local add/drop stage can access single wavelengths or sub-subbands. Like the division of the overall optical bandwidth as well, the local add/drop stage can either have a fixed or variable specification of the subband division. A second processing stage is consequently provided, by means of which the branched subbands can be divided again into individual wavelengths or sub-subbands and read out.

Since no regeneration takes place in the transparent optical network, the local add/drop stage can preferably be used to regenerate individual channels electronically if this is required as a result of signal distortions and noise. Moreover, in connection with optical sources that can be set in the wavelength, the local add/drop stage is particularly preferably also provided as a transponder. The local add/drop stage provides a local add/drop functionality for each modular optical network node, in particular for network devices such as OADMs, ring interconnects and OCC. As a result, by virtue of the modular optical network node a network device is able, irrespective of the its functionality, to decouple or add individual wavelengths or entire subbands locally.

In a preferred exemplary embodiment of the present invention, a module is provided for selecting subbands which additionally has at least one device for adapting the power levels. It is particularly preferred if said adaptation device is located following the demultiplexer or before the multiplexer respectively. As a result, the individual signals of the various subbands can be individually amplified or attenuated once more. A detailed compensation of power losses may be performed. The power level can be adapted here depending on the channel format in each case, with the user being able to choose whether to produce equal power levels or different power levels as desired. It is very particularly preferred if a tilting of the power spectrum can be performed by the adaptation device.

One very particularly preferred exemplary embodiment of a module of a modular optical network node provides a preselection means which is integrated in the subband multiplexing device and/or subband demultiplexing device. Integrated means that the subband multiplexing device or the subband demultiplexing device respectively performs the task of the preselection means, that is to say the subband multiplexing device or the subband demultiplexing device can preselect the subbands in a fixed, configurable or remotely configurable way.

In a further special exemplary embodiment, the modular optical network node comprises at least two modules for selecting subbands. This arrangement enables modular optical network nodes to divide an available optical bandwidth into optical subbands, and then to have the optical subbands processed by the associated central elements. As a result, for example in the case of networks with bidirectional transmission links, the signals of both directions can be processed separately and routed in different subbands. In addition, owing to the series connection of individual modules for selecting subbands, it is possible to produce modular optical network nodes with extended functionality.

A particularly preferred embodiment of a modular optical network node contains central elements having the same functionality. This creates a scalability of the modular optical network node with then same central elements. The identical functionality in combinations enables the number of subbands to be processed to be increased. By adding individual further central elements, the functionality of the modular optical network node can be extended.

The modular optical network node can be employed for the switching of information or the access to information, or a combination of both. It permits use as OADM, ring interconnect or OXC. It is particularly preferably employed in typical hierarchical network structures, comprising mesh or ring wide area networks, ring networks for the metropolitan area, and tree-form network topologies in the access area.

In a very particularly preferred exemplary embodiment, the modular optical network nodes, or individual components of the modular optical network node respectively, are provided redundantly in order to ensure protection of the optical paths and the network elements.

In a particularly preferred embodiment, the functionalities of the central elements of the modular optical network node may be different. This produces a scalable modular optical network node with different central elements. Various combinations of the modular optical network nodes by means of the modules for selecting subbands with central elements having different functionality permit the basic extension of the functionalities of the network nodes.

By virtue of said arrangement, the modular optical network node comprises either one or more optical switching stages, just as a plurality of subband demultiplexing devices or subband multiplexing devices, depending on the number of inbound and outbound fibers and the maximum number of subbands to be switched. In a particularly preferred embodiment, the optical network node is designed to be remotely configurable. As a result, the modification of the subband structure and the devices for adapting the power levels is possible by means of remote configuration. The remote configurability can be automatically performed on the one hand via a central network management system and on the other hand by means of suitable protocols.

The object is achieved in particular also by a method for transmitting optical signals in optical network devices via at least one module for selecting subbands and at least one central element, wherein the method comprises the following method steps: optical input signals are divided into optical subbands. The optical subbands are interconnected by the central elements and the optical subbands are recombined to form an output signal.

The object is also achieved by the use of an optical network node to realize a circuit with add/drop functionality; and/or a circuit with drop and continue functionality; and/or a circuit with multicast functionality; and/or a circuit with broadcast functionality; and/or a circuit with ring interconnect functionality; and/or a circuit with cross-connect functionality.

Advantageous refinements of the invention are illustrated further in the drawings, in which:

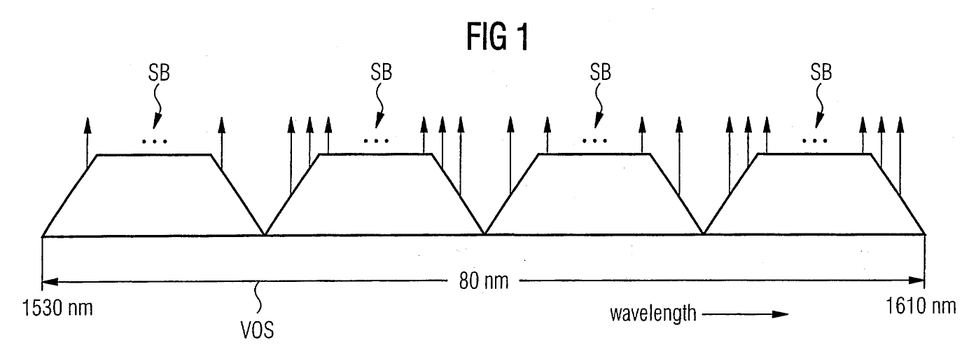

FIG. 1 shows a schematic illustration of an available optical bandwidth of an optical signal;

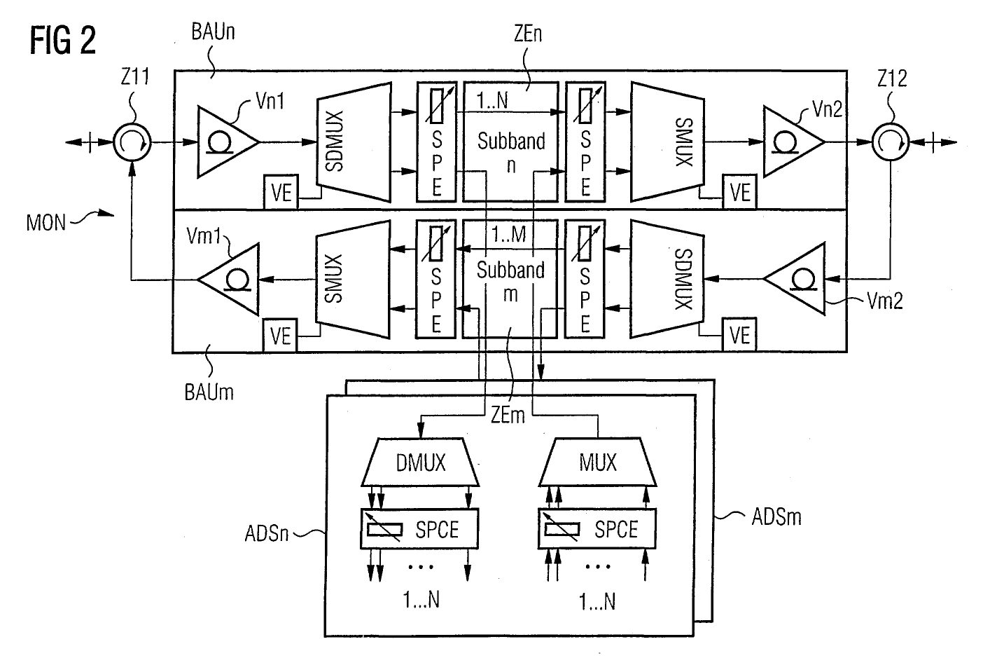

FIG. 2 shows an illustration of modular optical network nodes with add/drop multiplexer functionality;

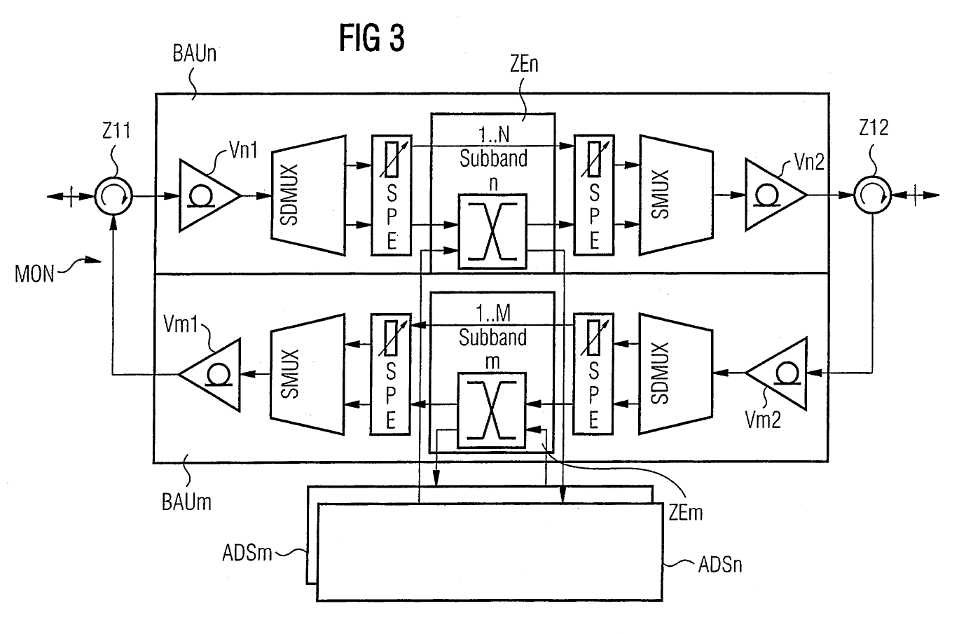

FIG. 3 shows an illustration of modular optical network nodes with drop and continue functionality;

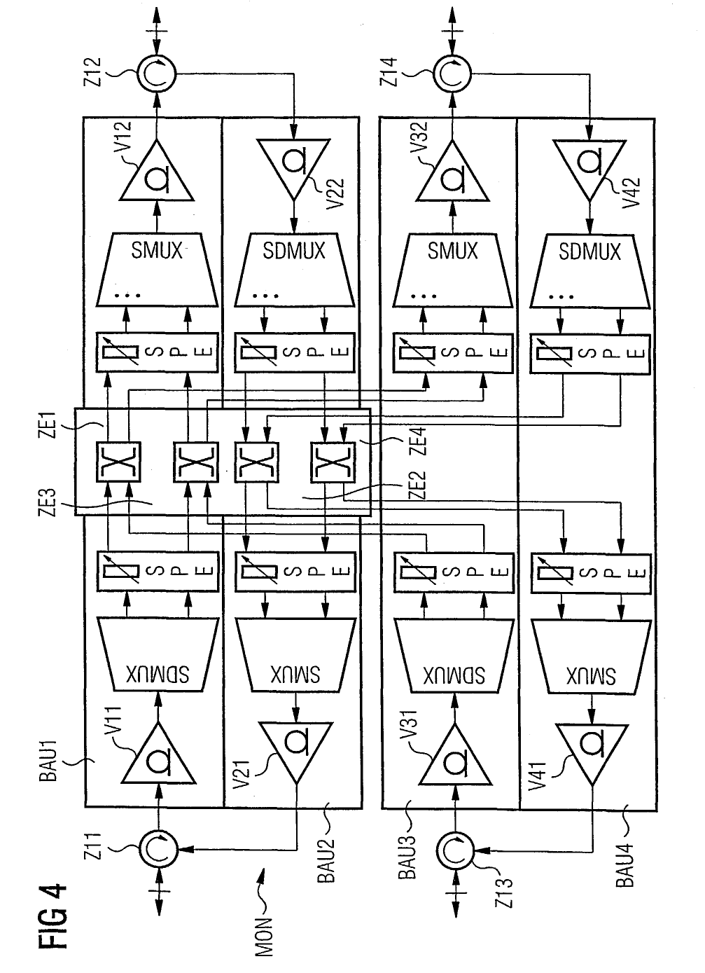

FIG. 4 shows an illustration of a ring interconnect containing modular optical network nodes; and

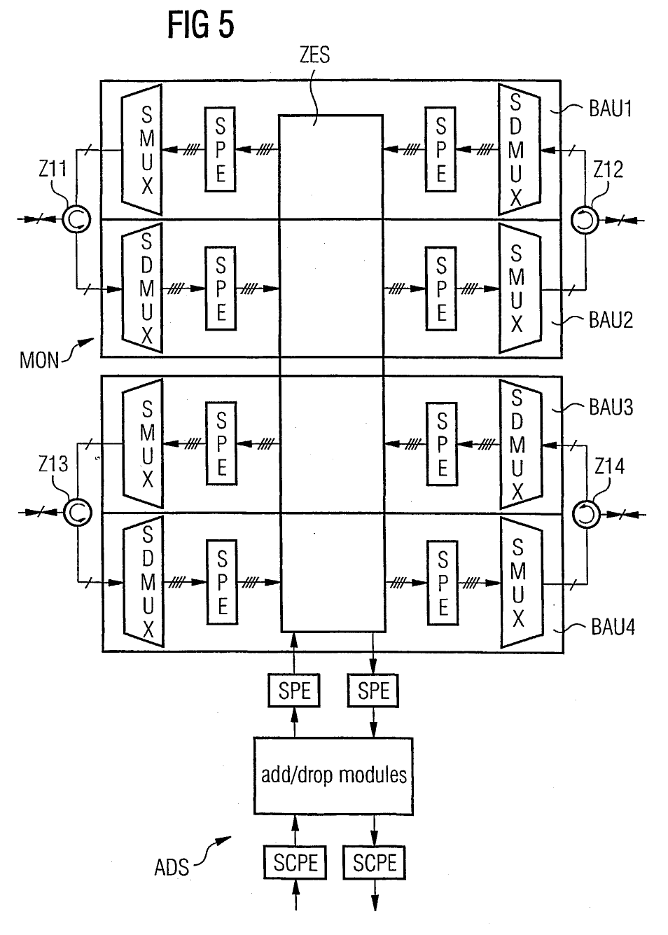

FIG. 5 shows an illustration of a cross-connect containing modular optical network nodes.

FIG. 1 is a schematic illustration of an available optical bandwidth VOS of an optical signal of 1530 nm to 1610 nm. The available optical bandwidth VOS can also be selected to be larger or smaller however. The division into subbands SB is performed according to the total available optical bandwidth VOS, which as a rule is given by the bandwidth of the fiber amplifiers typically employed and by the bandwidth requirements of the individual network elements. In FIG. 1 the total available optical bandwidth VOS is divided into four subbands.

The available optical bandwidth VOS is divided into four optical subbands SB by the subband multiplexing device SMUX or the subband demultiplexing device SDMUX respectively of a module for selecting subbands BAU of a modular optical network node MON. The division into four subbands SB is only by way of example, a division into more or fewer than four subbands SB is also possible. Optical subbands SB having the same bandwidth are illustrated in FIG. 1. The optical subbands SB can however also have different bandwidths. In the extreme case, the subband width of a subband SB can comprise only one wavelength.

Illustrated in FIG. 2 is an add/drop multiplexer in a bidirectional optical network. The add/drop multiplexer comprises two modules for selecting subbands BAUn, BAUm which are connected to one another via the circulators Z11, Z12. The circulators Z11, Z12 have the task of dividing the bidirectional fibers of a bidirectional network into two unidirectional links. The module for selecting subbands BAUn comprises two optical amplifiers Vn1, Vn2, one subband demultiplexing device SDMUX, one subband multiplexing device SMUX and two devices for adapting the power level SPE. Integrated in the subband demultiplexing device SDMUX is a preselection means VE for preselecting at least one optical subband SB. The same applies to the subband multiplexing device MUX. The module for selecting subbands BAUm is constructed analogously to the module for selecting subbands BAUn and is contradirectionally arranged.

The interconnection of the subbands in modular optical network nodes is performed via central elements. The module BAUn divides the available optical bandwidth VOS into N subbands. The N subbands are processed by N central elements. Illustrated in FIG. 2 is the nth central element ZEn which is responsible for interconnecting the nth subband. The module BAUm is linked to the central elements analogously. The M subbands of the module BAUm are processed by M central elements. Illustrated in FIG. 2 is the mth central element ZEm for processing the mth subband. Also illustrated are furthermore the add/drop stages ADSn, ADSm which provide a local add/drop functionality for the central elements ZEn, ZEm. The N central elements that correspond to the module BAUn are coupled to the N add/drop stages. The same applies analogously to the coupling of the M central elements that correspond to the module BAUm. The add/drop stages ADSn, ADSm comprises a multiplexing device MUX, a demultiplexing device DMUX and two devices for adapting the power level SPCE.

By means of the circulator Z11, an inbound bidirectional signal is fed to the module for selecting subbands BAUn of the modular optical network node MON and amplified by the optical amplifier Vn1. The subband demultiplexing device SDMUX extracts only the go direction of the bidirectional signal and divides the available optical bandwidth VOS of the signal into 1-N subbands SB as specified by the preselection means VEn.

The level differences of the 1-N subbands SB can be equalized by the device for adapting the power level SPE. Via the central element ZEn with add/drop functionality, the nth subband SB can now be extracted, and if desired a new nth subband SB can be injected. If the nth subband SB is to be processed further, individual wavelengths or sub-subbands can be extracted locally via the add/drop stage ADSn. New individual wavelengths or sub-subbands can also be injected by means of the add/drop stage ADSn. The nth subband SB processed by the central element ZEn with add/drop functionality is again adapted by the device for adapting the power level SPE. The 1-N subbands are recombined by the subband multiplexing device SMUX, amplified by the amplifier Vn2 and injected into the bidirectional fiber via the circulator Z12. Analogously, a bidirectional signal is processed in the return direction by the module for selecting subbands BAUm for the bandwidth 1-M in the opposite direction.

The separation of the optical signal into subbands SB is performed by the subband demultipiexing device SDMUX. In the subband demultiplexing device SDMUX, optical filter components are employed to separate the available optical bandwidth VOS. As filter technology it is possible to use here, for example, integrated optical (e.g. Mach-Zehnder filter), fiber-optic (e.g. fiber Bragg grating) or dielectric filters which can be employed either as bandpass or band rejection filters. In addition, the arrangement of the filter components in the subband demultiplexing devices SDMUX can be either as filters and couplers/circulators or else as a complete demultiplexer. The interconnection can be performed via couplers or circulators or combinations of both. In addition, an interconnection can also be performed via complete multiplexers. By means of the filter elements, subbands of fixed or variable width, subbands with adjustable or fixed mid-wavelength and combinations of both can be produced by the filter elements.

Level differences between the individual subbands, caused for example by different link losses or component attenuation that the individual subbands SB have experienced, are equalized with the device for adapting the power levels SPE. The device for adapting the power levels SPE are preferably equipped with variable attenuation elements. It is very particularly preferred if devices for adapting the power levels which are software-reconfigurable are used here.

The central elements ZEn, ZEm serve to extract subbands SB and insert new signals on the subband level. The further processing can be carried out by means of the add/drop stage ADSn, ADSm for individual wavelengths or else for sub-subbands through to subbands with the entire predetermined subband width. For this reason a combination of optical filters, preferably narrowband optical filters, couplers or circulators is provided within the add/drop stage ADSn, ADSm, wherein the filters in turn may be of fiber-optic, integrated-optical or dielectric design and can have a tunable or fixed wavelength. In turn it is also possible to use filters having a variable bandwidth, so that a plurality of wavelength channels (e.g. small subbands) can be extracted and inserted with one filter stage. It is particularly preferred if a multiplexing device MUX or a subband demultiplexing device DMUX is provided, and very particularly preferred if a multiplexing device SMUX or a subband demultiplexing device SDMUX is provided.

The optical amplifiers Vn1, Vn2 may be required for equalizing the link losses. It is however also possible to use active optical components in the individual stages of the network node which perform, for example, not only a coupling or filter function, but at the same time can also co-perform an amplification of the signals by virtue of their physical characteristics (made of semiconductor material or erbium-doped waveguide).

The add/drop multiplexer for bidirectional networks described in FIG. 2 can also be used in unidirectional networks.

Illustrated in FIG. 3 is an identical structure to FIG. 2. Only the central elements ZEn, ZEn which comprise a circuit with drop and continue functionality, or with multicast functionality respectively, are changed. The circuits here consist of a space switching stage with drop and continue capability.

The central elements ZEn, ZEm allow a wavelength or a subband in the node to be extracted and a new wavelength or band inserted (add/drop functionality). It is particularly preferred if the inbound subbands can be routed to the add/drop stage ADSn, ADSm preselection means on the one hand, and simultaneously forwarded to the output fiber without a new subband being added (multicast/broadcast functionality, drop and continue functionality). Different realizations and a different structure (one-stage/multi-stage) can be used for the switching stage. The use of switching matrices in which the number of switching elements can be reduced, such as switching matrices according to CLOS and BENES for example, is particularly preferred as switching stage. Depending on type and use, the switching matrices can be selected to be strictly non-blocking or not strictly non-blocking.

The modular optical network node MON with drop and continue functionality for bidirectional networks described in FIG. 3 can also be used in unidirectional networks.

FIG. 4 illustrates the use of a modular optical network node as a ring interconnect. The modules for selecting subbands BAU1-BAU4 are now illustrated. Each module divides the available optical bandwidth VOS into subbands SB. Each of the subbands is processed by a central element. Illustrated in FIG. 4 is the processing of a subband per module for selecting subbands BAU1-BAU4 by a central element ZE1-ZE4. Each of the central elements ZE1-ZE4 of the respective modules for selecting subbands BAU1-BAU4 has a space switching stage. It is particularly preferred if the space switching stages have drop and continue functionality. Different realizations and a different structure (one-stage/multi-stage) can be used for the space switching stages. In addition, it is advantageous that it is possible to connect local add/drop stages ADS1-ADS4 (not shown) with the associated characteristics to the central elements ZE1-ZE4. The space switching stages are connected to one another in such a way that a central element ZE1 of the first module for selecting subbands BAU1 is connected to the module for selecting subbands BAU3, and a central element ZE3 of the module for selecting subbands BAU3 is connected to the module for selecting subbands BAU1. In addition, a central element ZE2 of the module for selecting subbands BAU2 is connected to the module for selecting subbands BAU4, and a central element ZE4 of the module for selecting subbands BAU4 is connected to the module for selecting subbands BAU2.

Instead of the central elements ZE1-ZE4, it is particularly preferred if a ring interconnect can have further central elements that represent combinations of the central elements ZE1-ZE4 (e.g. one central element for the go direction from ZE1 and ZE3 and one central element for the return direction from ZE2 and ZE4). It is very particularly preferred if the ring interconnect has a central element switching stage ZES.

The ring interconnect for bidirectional networks described in FIG. 4 can also be used in unidirectional networks.

FIG. 5 illustrates the use of a modular optical network node MON as a cross-connect. Four modules for selecting subbands BAU1-BAU4 are illustrated here. The respective central elements of the module for selecting subbands BAU1-BAU4 are represented as a central element switching stage ZES. The central element switching stage ZES has a switching matrix which can be constructed using, for example, micromechanical switches, integrated optical switches, liquid crystal switches, and enables a switching of the subbands between the inbound and the outbound fibers. In addition to a pure switching characteristic, the switching matrix can also have a drop and continue or multicast or add/drop capabilities.

The cross-connect for bidirectional networks described in FIG. 5 can also be used in unidirectional networks.

The modular optical network node according to the invention provided a flexible and low-cost realization for high transmission capacities and large numbers of channels. The invention relates to a modular optical network node which divides optical input signals into optical subbands, processed by a central element or by a plurality of central elements, and then recombines the optical subbands again to form an optical output signal. The central element or central elements of the modular optical network node can be assigned different functionalities, such as an add/drop functionality, a drop and continue functionality, a multicast functionality, a broadcast functionality, a ring interconnect functionality and a cross-connect functionality. Depending on the assignment of a functionality, the a modular optical network node can be employed in networks having a different structure.

1. A modular optical network node (MON) comprising at least one module (BAU) for selecting subbands, in which the module (BAU) has at least one subband multiplexing device (SMUX) and at least one subband demultiplexing device (SDMUX), and additionally at least one central element (ZE) is provided, characterized in that the module (BAU) comprises a preselection means (VE) for preselecting at least one optical subband (SB), and in that the optical subbands (SB) can be dynamically selected by the module (BAU).

2. The modular optical network node (MON) as claimed in one of the preceding claims, characterized in that the optical subbands (SB) can be selected by the module (BAU) around at least one central frequency.

3. The modular optical network node (MON) as claimed in one of the preceding claims, characterized in that the central element (ZE) comprises a circuit with add/drop functionality.

4. The modular optical network node (MON) as claimed in one of the preceding claims, characterized in that the central element (ZE) comprises a circuit with drop and continue functionality.

5. The modular optical network node (MON) as claimed in one of the preceding claims, characterized in that the central element (ZE) comprises a circuit with multicast functionality.

6. The modular optical network node (MON) as claimed in one of the preceding claims, characterized in that the central element (ZE) comprises a circuit with broadcast functionality.

7. The modular optical network node (MON) as claimed in one of the preceding claims, characterized in that the central element (ZE) comprises a circuit with ring interconnect functionality.

8. The modular optical network node (MON) as claimed in one of the preceding claims, characterized in that the central element (ZE) comprises a circuit with cross-connect functionality.

9. The modular optical network node (MON) as claimed in one of the preceding claims, characterized in that the central element (ZE) has at least one local add/drop stage (ADS).

10. The modular optical network node (MON) as claimed in one of the preceding claims, characterized in that the module (BAU) has at least one devices for adapting the power level (SPE, SCPE).

11. The modular optical network node (MON) as claimed in one of the preceding claims, characterized in that the preselection means (VE) is integrated in the subband multiplexing device (SMUX) and/or the subband demultiplexing device (SDMUX).

12. A modular optical network node (MON), characterized in that the modular optical network node (MON) comprises at least two modules (BAU).

13. A method for transmitting optical signals in optical network devices via a modular optical network node (MON) as claimed in the preceding claims, characterized in that it comprises the following method steps:
division of an optical input signal into optical subbands (SB);
processing of the optical subbands (SB) by at least one central element (ZE);
recombination of the optical subbands (SB) to form an optical output signal.

14. The use of modular optical network nodes (MON) as claimed in one of the preceding claims to realize a circuit with add/drop functionality.

15. The use of modular optical network nodes (MON) as claimed in one of the preceding claims to realize a circuit with drop and continue functionality.

16. The use of modular optical network nodes (MON) as claimed in one of the preceding claims to realize a circuit with multicast functionality.

17. The use of modular optical network nodes (MON) as claimed in one of the preceding claims to realize a circuit with broadcast functionality.

18. The use of modular optical network nodes (MON) as claimed in one of the preceding claims to realize a circuit with ring interconnect functionality.

19. The use of modular optical network nodes (MON) as claimed in one of the preceding claims to realize a circuit with cross-connect functionality.
